(19) United States
(12) Patent Application Publication
(10) Pub. No.: US 2012/0274793 A1
(43) Pub. Date: Nov. 1, 2012

(54) SYSTEM AND METHOD FOR SYNCHRONIZING VIDEO AND SENSOR SIGNALS

(75) Inventor: Song Hwan Choi, Daejeon (KR)

(73) Assignee: RD-TEK CO., LTD., Daejeon (KR)

(21) Appl. No.: 13/514,029

(22) PCT Filed: Dec. 3, 2010
(86) PCT No.: PCT/KR2010/008624

§ 371 Date: Jun. 5, 2012

(30) Foreign Application Priority Data
Dec. 8, 2009 (KR) 10-2009-0120946

(51) Int. Cl. H04N 5/04; H04N 5/228

(52) U.S. Cl. 348/207.11; 348/E05.009; 348/E05.031

(57) ABSTRACT

A system synchronizing video and sensor signals includes: a camera with first synchronization clock, acquiring the video signal, adding acquisition time of first synchronization clock to the video signal; a sensor with second synchronization clock, generating the sensor signal corresponding to the video signal according to sensing operation, adding acquisition time of second synchronization clock to the sensor signal; a controller controlling to receive the sensor signal added with the acquisition time from the sensor and transmit the sensor signal to a computer; a synchronizer with reference clock, transmitting reference time for synchronizing the first and second synchronization clocks to the camera and the sensor; and a computer receiving the sensor signal added with the acquisition time from the controller, receiving the video signal added with the acquisition time from the camera, confirming the acquisition time of the signals, reconfiguring the signals in the same time zone, synchronizing the signals.

### TECHNICAL FIELD

The present invention relates to a system and method for synchronizing a video signal and a sensor signal when analyzing multi-channel video signals and sensor signals in a wired or wireless environment, and more specifically, a synchronization clock is embedded in each sensor module and a camera apparatus to synchronize the video signal inputted from a camera and the sensor signal corresponding to each video signal. A synchronization apparatus transmits a synchronization signal to each apparatus, and the synchronization clocks are synchronized according to the synchronization signal. The signals acquired by each sensor module and the camera apparatus are added with an acquisition time and transmitted to a central control apparatus and a computer apparatus, and synchronization is performed for the video signal and the sensor signal.

BACKGROUND ART

Recently, a camera for photographing a subject and acquiring a video signal is adopted and used in a cellular phone or a notebook computer carried by a user. In addition, apparatuses for utilizing the video signal acquired through the camera in a gaming device or the like such as an archery analyzer are introduced.

The gaming device or the like is provided with a sensor for sensing surrounding circumstances, e.g., sensing wind directions or wind speed or sensing tension, a slope, temperature or pressure.

However, when it needs to match the video signal acquired from the camera to a sensor signal sensed through a sensor and provide the signals to a user, synchronization of the two signals is very important to improve quality of service.

However, when the video signal or the sensor signal needs to be transmitted in a high-speed wireless communication on a multi-channel of at least two or more channels, synchronization of individual signals collected according to surrounding environments is very difficult to secure.

### DISCLOSURE OF INVENTION

### Technical Problem

Therefore, the present invention has been made in view of the above problems, and it is an object of the present invention to provide a system and method for synchronizing a video signal and a sensor signal, a camera apparatus, a synchronization apparatus and a method of synchronizing a video signal and a sensor signal thereof, and a computer apparatus and a method of synchronizing a video signal and a sensor signal thereof, in which a synchronization clock is embedded in each sensor module and a camera apparatus to synchronize the video signal inputted from a camera and the sensor signal corresponding to each video signal. The synchronization apparatus transmits a synchronization signal to each apparatus, and the synchronization clocks are synchronized according to the synchronization signal. Then, signals acquired by each sensor module and the camera apparatus are added with an acquisition time and transmitted to a central control apparatus and a computer apparatus, and synchronization is performed for the video signal and the sensor signal.

### Technical Solution

To accomplish the above object, according to one aspect of the present invention, there is provided a system for synchronizing a video signal and a sensor signal, the system comprising: a camera apparatus embedded with a first synchronization clock, for acquiring the video signal by photographing a subject, adding acquisition time information of the first synchronization clock to the acquired video signal, and outputting the video signal; a sensor apparatus embedded with a second synchronization clock, for generating the sensor signal corresponding to the video signal according to a sensing operation, adding acquisition time information of the second synchronization clock to the generated sensor signal, and outputting the sensor signal; a central control apparatus for controlling to receive the sensor signal added with the acquisition time information from the sensor apparatus and transmit the sensor signal to a computer apparatus; a synchronization apparatus embedded with a reference clock, for simultaneously transmitting a reference time for synchronizing the first synchronization clock and the second synchronization clock to the camera apparatus and the sensor apparatus at regular intervals; and a computer apparatus for receiving the sensor signal added with the acquisition time information from the central control apparatus, receiving the video signal added with the acquisition time information from the camera apparatus, confirming the acquisition time information of each of the video signal and the sensor signal, reconfiguring each of the signals in the same time zone, and synchronizing the video signal and the sensor signal.

In addition, the camera apparatus synchronizes the first synchronization clock based on the reference time received from the synchronization apparatus, adds acquisition time information of the first synchronization clock to the photographed and acquired video signal, and transmits the video signal to the computer apparatus.

In addition, the sensor apparatus synchronizes the second synchronization clock based on the reference time received from the synchronization apparatus, adds acquisition time information of the second synchronization clock to the sensor signal generated according to a sensing operation, and transmits the sensor signal to the central control apparatus.

In addition, the sensor apparatus compares the reference time received from the synchronization apparatus with a time of the second synchronization clock, perform correction as much as a time difference, adds acquisition time information to the sensor signal based on the corrected time, and transmits the sensor signal to the central control apparatus.

In addition, the camera apparatus and the sensor apparatus obtain a time difference by comparing the reference time received from the synchronization apparatus with a time of the first synchronization clock and a time of the second synchronization clock, and transmit the obtained time difference to the computer apparatus respectively, and the computer apparatus corrects the video signal and the sensor signal as much as the time difference on the time axis.

In addition, the synchronization apparatus requests and acquires current time information from the sensor apparatus, confirms a time difference range by comparing the acquired current time information with reference time information, and transmits time information and a time correction command to the sensor apparatus if correction is needed.

In addition, if the time correction command is received, the sensor apparatus performs correction based on the time information, performs synchronization using a clock received from the synchronization apparatus at the second clock, and transmits a correction completion command to the synchronization apparatus.

According to another aspect of the present invention, there is provided a synchronization apparatus comprising: a communication unit for communicating with a camera apparatus, a sensor apparatus, a central control apparatus and a computer apparatus; a frequency generation unit (oscillator) for generating a frequency signal in order to transmit reference time information for synchronization to the camera apparatus, the sensor apparatus, the central control apparatus and the computer apparatus; a synchronization clock unit for generating a clock signal from the generated frequency signal; a reference time module unit (FPGA) for generating the reference time information from the generated clock signal; a real-time clock (RTC) unit for providing the reference time module unit with a real time clock (RTC); and a control unit for controlling the frequency generation unit, the synchronization clock unit and the reference time module unit to generate the reference time information and transmit the generated reference time information to the camera apparatus, the sensor apparatus, the central control apparatus and the computer apparatus.

In addition, the control unit requests and acquires current time information from the sensor apparatus, confirms a time difference range by comparing the acquired current time information with the reference time information, and transmits time information and a time correction command to the sensor apparatus if correction is needed.

In addition, the synchronization apparatus further comprises an A/D converter for converting an analog signal inputted from the camera apparatus, the sensor apparatus, the central control apparatus and the computer apparatus into a digital signal; an output unit for outputting the digital signal; and a display unit for displaying an operation of generating the reference time information, the current time information and an operation of transmitting the time correction command.

According to another aspect of the present invention, there is provided a sensor apparatus comprising: a sensor for generating a sensor signal sensing a slope, tension, weight or the like; a signal conversion unit for converting the sensor signal of an analog form into sensor data of a digital form; a communication unit for transmitting the sensor data to a synchronization apparatus and a central control apparatus; a synchronization clock unit for performing synchronization using a reference time provided by the synchronization apparatus; a memory unit for storing the sensor data; a control unit for controlling to transmit the sensor data to the central control apparatus, receive the reference time from the synchronization apparatus and perform synchronization using the reference time, and transmit acquisition time information of the sensor data to the central control apparatus together with the sensor data; a frequency generation unit for generating a frequency signal and providing the control unit with the frequency signal; and a real-time clock module (RTC) unit for providing the control unit with a real time clock (RTC).

According to another aspect of the present invention, there is provided a camera apparatus comprising: a photographing unit for acquiring a video signal by photographing a subject; a communication unit for transmitting the video signal to a computer apparatus or a central control apparatus and communicating with a synchronization apparatus; and a synchronization clock unit synchronized to a reference time received from the synchronization apparatus and providing a time of acquiring the video signal.

According to another aspect of the present invention, there is provided a method of synchronizing a video signal and a sensor signal of a system including a camera apparatus, a sensor apparatus, a central control apparatus, a synchronization apparatus and a computer apparatus, the method comprising the steps of: (a) transmitting synchronization time information to the camera apparatus an& the sensor apparatuses by the synchronization apparatus; (b) synchronizing an embedded synchronization clock based on the synchronization time information by the camera apparatus and the sensor apparatus, respectively; (c) acquiring the video signal and the sensor signal, adding acquisition time information, and transmitting the video signal and the sensor signal to the computer apparatus and the central control apparatus by the camera apparatus and the sensor apparatus, respectively; and (d) performing synchronization of the video signal and the sensor signal based on the acquisition time information by the computer apparatus.

In addition, in step (c), the central control apparatus transmits the sensor signal added with the acquisition time information to the computer apparatus.

In addition, in step (d), the computer apparatus calculates a time difference by comparing the acquisition time information of the camera apparatus and the sensor apparatus and synchronizes the video signal and the sensor signal by correcting the video signal and the sensor signal as much as the time difference on the time axis.

According to another aspect of the present invention, there is provided a method of synchronizing a video signal and a sensor signal of a synchronization apparatus communicating with an apparatus including a camera apparatus, a sensor apparatus, a central control apparatus and a computer apparatus through a wired or wireless communication, the method comprising the steps of: (a) requesting and receiving current time information from the apparatus; (b) acquiring time difference information by comparing the current time information with reference time information; (c) generating time information for correcting the time difference information, and transmitting the time information and a time correction command to the apparatus; and (d) receiving a synchronization completion command informing completion of synchronization as a time correction performed based on the time information, from the apparatus.

According to another aspect of the present invention, there is provided a method of synchronizing a video signal and a sensor signal of a computer apparatus communicating with a camera apparatus, a sensor apparatus, a central control apparatus and a synchronization apparatus through a wired or wireless communication, the method comprising the steps of: (a) receiving reference time information from the synchronization apparatus and synchronizing an embedded synchronization clock; (b) receiving the video signal added with acquisition time information from the camera apparatus, and receiving the sensor signal acquired by the sensor apparatus and added with acquisition time information from the central control apparatus; and (c) synchronizing the video signal and the sensor signal based on the acquisition time information.

In addition, step (c) calculates a time difference by comparing the acquisition time information of the camera apparatus and the sensor apparatus and synchronizes the video signal and the sensor signal by correcting the video signal and the sensor signal as much as the time difference on the time axis.

### Advantageous Effects

According to the present invention, synchronization of video signals and sensor signals collected depending on surrounding environments can be secured.

In addition, users can be provided with improved services through synchronization of multi-channel high-speed video signals and sensor signals corresponding thereto.

Furthermore, synchronization of the two signals can be easily implemented regardless of a communication means which acquires video signals and sensor signals and transmits the signals in a wired or wireless communication, and accordingly, the video signals and the sensor signals can be correctly and conveniently analyzed.

### BRIEF DESCRIPTION OF THE DRAWINGS

FIG. 1 is a view schematically showing the configuration of a system for synchronizing a video signal and a sensor signal according to an embodiment of the present invention.

FIG. 2 is a view schematically showing the internal configuration of a synchronization apparatus according to an embodiment of the present invention.

FIG. 3 is a view schematically showing the internal configuration of a sensor apparatus according to an embodiment of the present invention.

FIG. 4 is a view schematically showing the internal configuration of a camera apparatus according to an embodiment of the present invention.

FIG. 5 is an overall flowchart illustrating a method of synchronizing a video signal and a sensor signal according to an embodiment of the present invention.

FIG. 6 is a flowchart illustrating a method of synchronizing a video signal and a sensor signal of a synchronization apparatus according to an embodiment of the present invention.

FIG. 7 is a view showing a synchronization procedure and a timing diagram according to an embodiment of the present invention.

FIG. 8 is a flowchart illustrating a method of synchronizing a video signal and a sensor signal of a computer apparatus according to an embodiment of the present invention.

### BEST MODE FOR CARRYING OUT THE INVENTION

The preferred embodiments of the present invention will be hereafter described in detail, with reference to the accompanying drawings. Furthermore, in the drawings illustrating the embodiments of the present invention, elements having like functions will be denoted by like reference numerals and details thereon will not be repeated.

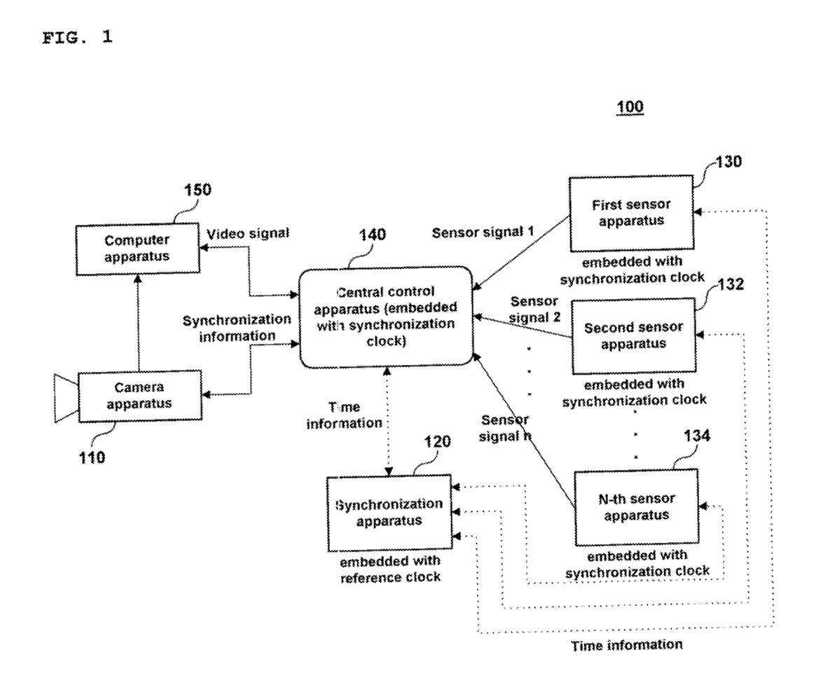

FIG. 1 is a view schematically showing the configuration of a system for synchronizing a video signal and a sensor signal according to an embodiment of the present invention.

Referring to FIG. 1, the system for synchronizing a video signal and a sensor signal 100 according to the present invention includes a camera apparatus 110, a synchronization apparatus 120, a plurality of sensor apparatuses 130 to 134, a central control apparatus 140 and a computer apparatus 150.

The camera apparatus 110 is embedded with a first synchronization clock, acquires a video signal by photographing a subject, adds acquisition time information of the first synchronization clock to the acquired video signal, and outputs and transmits the video signal to the computer apparatus 150.

The synchronization apparatus 120 is embedded with a reference clock and simultaneously transmits a reference time for synchronizing the camera apparatus 110, the sensor apparatuses 130 to 134 and the central control apparatus 140 to the camera apparatus 110, the sensor apparatuses 130 to 134 and the central control apparatus 140 at regular intervals.

The plurality of sensor apparatuses 130 to 134 is embedded with a second synchronization clock, generates a sensor signal corresponding to the video signal according to a sensing operation, adds acquisition time information of the second synchronization clock to the generated sensor signal, and outputs and transmits the sensor signal to the central control apparatus 140.

Here, the plurality of sensor apparatuses 130 to 134, for example, may be an archery analyzer for sensing a slope of an arrow or tension, a foot motion analyzer (X-balance) for sensing foot motions of a user in forward, backward, left and right directions, or a climate analyzer for sensing wind directions or wind speed in the surroundings. At this point, tension, a slope or like can be a sensor signal in the case of the archery analyzer, front, rear, left or right can be a sensor signal in the case of the foot motion analyzer, and wind directions or wind speed can be a sensor signal in the case of the climate analyzer. Other than these, temperature, pressure or the like can be a sensor signal depending on sensing characteristics of a sensor.

The central control apparatus 140 controls to receive the sensor signal added with the acquisition time information from the sensor apparatuses 130 to 134 and transmit the sensor signal to the computer apparatus 150.

The computer apparatus 150 receives the sensor signal added with the acquisition time information from the central control apparatus 140, receives the video signal added with the acquisition time information from the camera apparatus 110, confirms the acquisition time information of each of the video signal and the sensor signal, reconfigures each of the signals in the same time zone, and synchronizes the video signal and the sensor signal. Here, the computer apparatus may be a desktop PC or a portable notebook PC.

In addition, the camera apparatus 110 synchronizes the first synchronization clock based on the reference time received from the synchronization apparatus 120, adds acquisition time information of the first synchronization clock to the photographed and acquired video signal, and transmits the video signal to the computer apparatus 150.

In addition, the sensor apparatuses 130 to 134 synchronize the second synchronization clock based on the reference time received from the synchronization apparatus 120, add acquisition time information of the second synchronization clock to the sensor signal generated according to a sensing operation, and transmit the sensor signal to the central control apparatus 140.

In addition, the sensor apparatuses 130 to 134 compare the reference time received from the synchronization apparatus 120 with the time of the second synchronization clock, perform correction as much as a time difference, add acquisition time information to the sensor signal based on the corrected time, and transmit the sensor signal to the central control apparatus 140.

In addition, the camera apparatus 110 and the sensor apparatuses 130 to 134 obtain a time difference by comparing the reference time received from the synchronization apparatus 120 with the time of the first synchronization clock and the time of the second synchronization clock, and transmit the obtained time difference to the computer apparatus 150, respectively, and the computer apparatus 150 corrects the video signal and the sensor signal as much as the time difference on the time axis.

In addition, the synchronization apparatus 120 requests and acquires current time information from the sensor apparatuses 130 to 134, confirms a time difference range by comparing the acquired current time information with the reference time information, and transmits time information and a time correction command to the sensor apparatuses 130 to 134 if correction is needed.

In addition, if the time correction command is received, the sensor apparatuses 130 to 134 perform correction based on the received time information, perform synchronization using a clock received from the synchronization apparatus 120 at the second clock, and transmit a synchronization (correction) completion command to the synchronization apparatus 120.

FIG. 2 is a view schematically showing the internal configuration of a synchronization apparatus according to an embodiment of the present invention.

Referring to FIG. 2, the synchronization apparatus 120 according to the present invention includes a communication unit 210, a frequency generation unit (oscillator) 220, a synchronization clock unit 230, a reference time module unit 240, a real-time clock unit 25C, a control unit 260, an analog to digital (A/D) converter 270, an output unit 280 and a display unit 290.

The communication unit 210 communicates with the camera apparatus 110, the sensor apparatuses 130 to 134, the central control apparatus 140 and the computer apparatus 150.

The frequency generation unit 220 generates a frequency signal in order to transmit reference time information for synchronization to the camera apparatus 110, the sensor apparatuses 130 to 134, the central control apparatus 140 and the computer apparatus 150.

The synchronization clock unit 230 generates a clock signal from the frequency signal generated by the frequency generation unit 220.

The reference time module unit 240 generates the reference time information from the generated clock signal.

The real-time clock unit 250 provides the reference time module unit 240 with a real time clock (RTC).

The control unit 260 controls the frequency generation unit 220, the synchronization clock unit 230 and the reference time module unit 240 to generate reference time information and transmit the generated reference time information to the camera apparatus 110, the sensor apparatuses 130 to 134, the central control apparatus 140 and the computer apparatus 150.

In addition, the control unit 260 requests and acquires current time information from the sensor apparatuses 130 to 134, confirms a time difference range by comparing the acquired current time information with the reference time information, and transmits time information and a time correction command to the sensor apparatuses 130 to 134 if correction is needed.

The A/D converter 270 converts an analog signal inputted from the camera apparatus 110, the sensor apparatuses 130 to 134, the central control apparatus 140 and the computer apparatus 150 into a digital signal.

The output unit 280 outputs the digital signal to outside through a port.

The display unit 290 displays the operation of generating the reference time information, the current time information, and the operation of transmitting the time correction command.

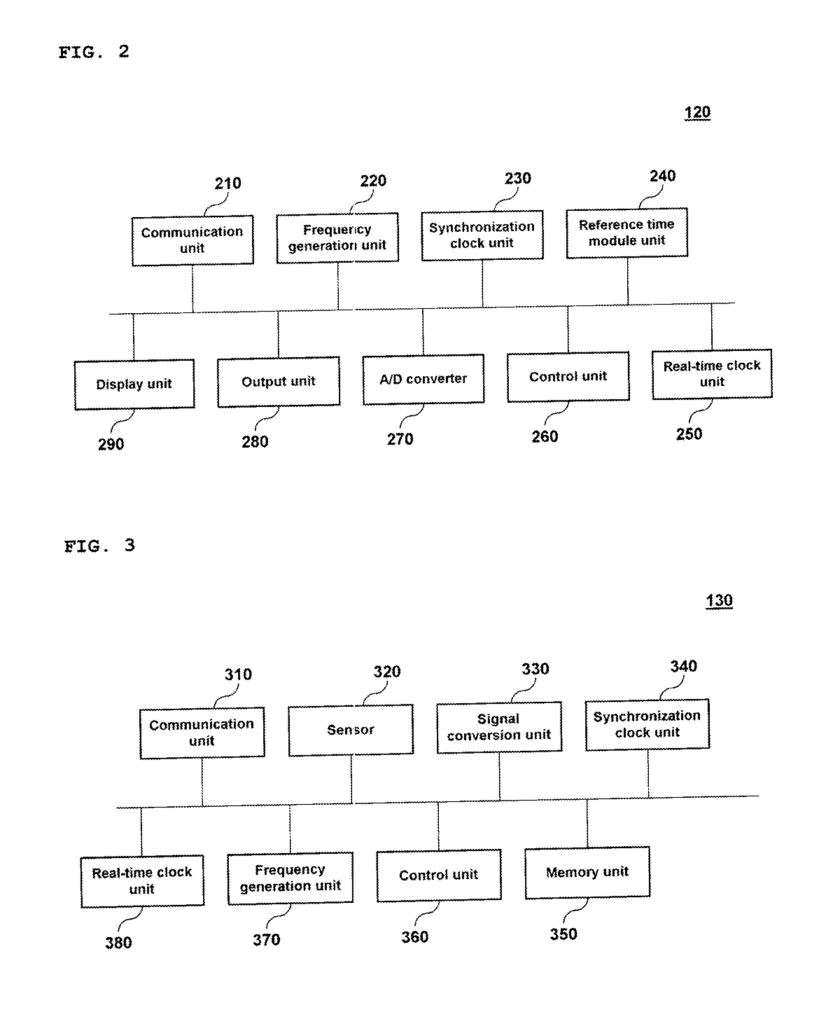

FIG. 3 is a view schematically showing the internal configuration of a sensor apparatus according to an embodiment of the present invention.

Referring to FIG. 3, the sensor apparatus 130 according to the present invention includes a communication unit 310, a sensor 320, a signal conversion unit 330, a synchronization clock unit 340, a memory unit 350, a control unit 360, a frequency generation unit 370 and a real-time clock unit 380.

The communication unit 310 transmits sensor data to the synchronization apparatus 120 and the central control apparatus 140.

The sensor 320 generates a sensor signal sensing a slope, tension, weight or the like.

The signal conversion unit 330 converts the sensor signal of an analog form into sensor data of a digital form.

The synchronization clock unit 340 performs synchronization using the reference time provided by the synchronization apparatus 123.

The memory unit 350 stores the sensor data.

The control unit 360 controls to transmit the sensor data to the central control apparatus 140, receive a reference time from the synchronization apparatus 120 and perform synchronization using the reference time, and transmit acquisition time information of the sensor data to the central control apparatus 140 together with the sensor data.

The frequency generation unit 370 generates a frequency signal and provides the control unit 460 with the frequency signal.

The real-time clock unit 380 provides the control unit 460 with a real time clock.

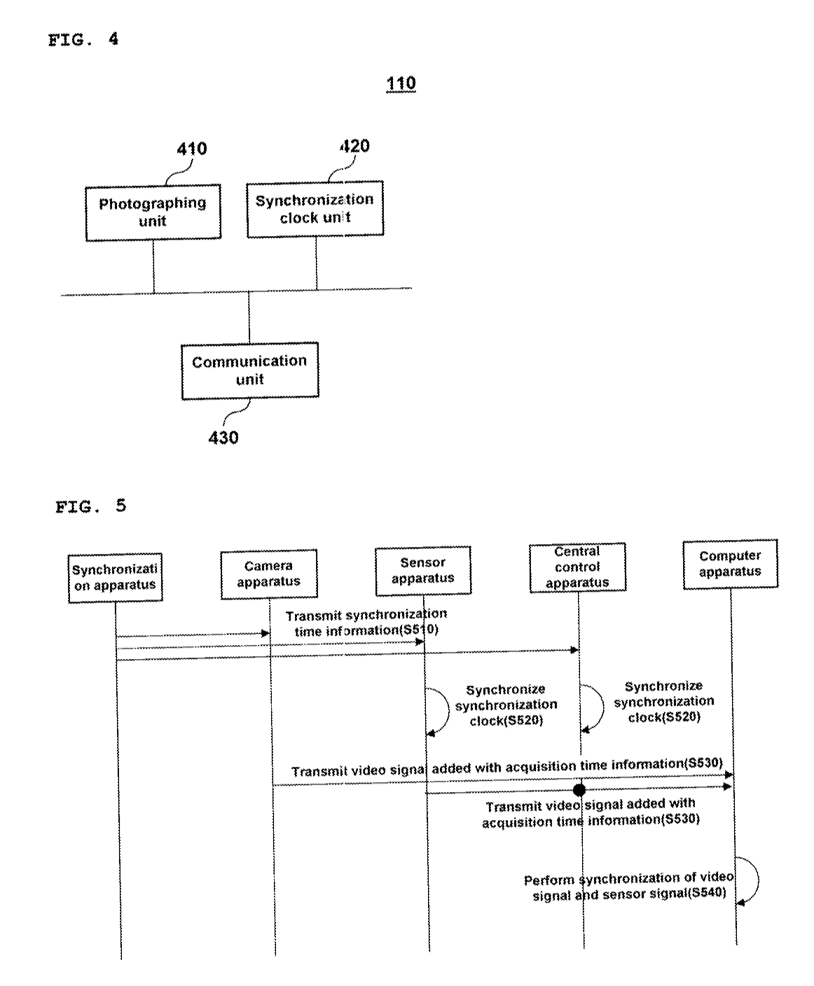

FIG. 4 is a view schematically showing the internal configuration of a camera apparatus according to an embodiment of the present invention.

Referring to FIG. 4, the camera apparatus 110 according to the present invention includes a photographing unit 410, a synchronization clock unit 420 and a communication unit 430.

The photographing unit 410 acquires a video signal by photographing a subject.

The synchronization clock unit 420 is synchronized to the reference time received from the synchronization apparatus 120 and provides a time of acquiring the video signal based on the synchronized time.

The communication unit 430 transmits the video signal to the computer apparatus 150 or the central control apparatus 140 and communicates with the synchronization apparatus 120 through a wired or wireless communication.

FIG. 5 is an overall flowchart illustrating a method of synchronizing a video signal and a sensor signal according to an embodiment of the present invention.

Referring to FIG. 5, first, the synchronization apparatus 120 transmits synchronization time information to the camera apparatus 110 and the sensor apparatuses 130 to 134 S510.

Then, the camera apparatus 110 and the sensor apparatuses 130 to 134 synchronize an embedded synchronization clock based on the synchronization time information, respectively S520.

Next, the camera apparatus 110 and the sensor apparatuses 130 to 134 acquire a video signal and a sensor signal, add acquisition time information, and transmit the video signal and the sensor signal to the central control apparatus 140 and the computer apparatus 150, respectively S530.

Here, the video signal generally has a big size and thus is directly transmitted to the computer apparatus 150 as is added with the acquisition time information without passing through the central control apparatus 140.

At this point, the sensor apparatuses 130 to 134 transmit the sensor signal added with the acquisition time information to the central control apparatus 140, and the central control apparatus 140 transmits the sensor signal added with the acquisition time information to the computer apparatus 150.

Accordingly, the computer apparatus 150 performs synchronization of the video signal and the sensor signal based on the acquisition time information S540.

At this point, the computer apparatus 150 calculates a time difference by comparing the acquisition time information of the camera apparatus 110 and the sensor apparatuses 130 to 134 and synchronizes the video signal and the sensor signal by correcting the video signal and the sensor signal as much as the time difference on the time axis.

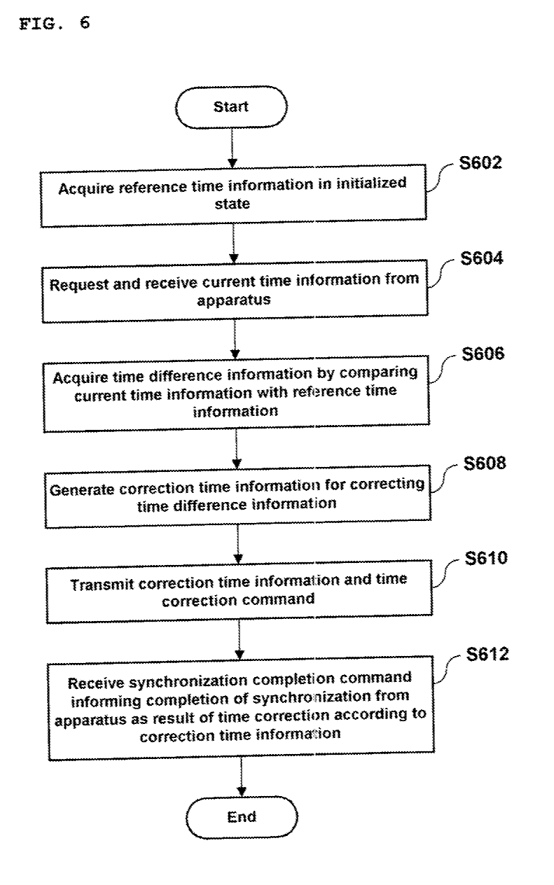

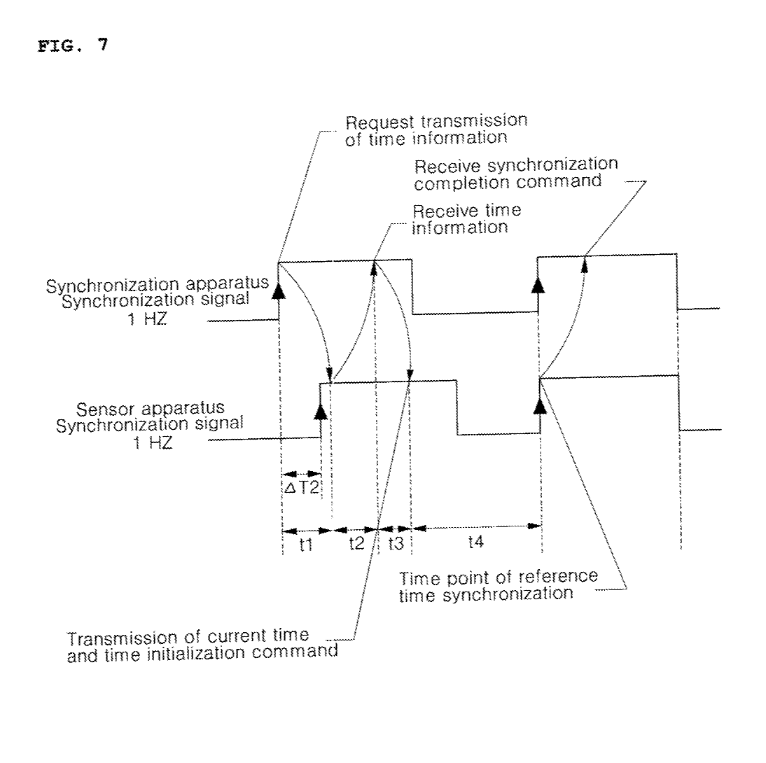

FIG. 6 is a flowchart illustrating a method of synchronizing a video signal and a sensor signal of a synchronization apparatus according to an embodiment of the present invention.

Referring to FIG. 6, the synchronization apparatus 120 according to the present invention acquires reference time information through the reference time module unit 240 while the system is initialized S602.

Next, the synchronization apparatus 120 requests and receives current time information as shown in FIG. 7 from the apparatus including the camera apparatus 110, the sensor apparatuses 130 to 134 and the central control apparatus 140 S604. FIG. 7 is a view showing a synchronization procedure and a timing diagram according to an embodiment of the present invention. In FIG. 7, ΔT1 denotes a time difference between the synchronization apparatus 120 and the sensor apparatuses 130 to 134 before time correction, Δt1 denotes a time information transmission delay time caused by a serial communication, Δt2 denotes a time of transmitting current time information from the sensor apparatuses 130 to 134, Δt3 denotes a time for confirming the time difference and setting a time and a command transfer delay time at the synchronization apparatus 120, and Δt4 denotes a time of waiting for correction after receiving time information from the synchronization apparatus 120.

Next, the synchronization apparatus 120 acquires time difference information by comparing the received current time information with the reference time information S606.

Next, the synchronization apparatus 120 generates correction time information for correcting the time difference information S608.

Next, the synchronization apparatus 120 transmits the generated correction time information and a time correction command to the apparatus including the camera apparatus 110, the sensor apparatuses 130 to 134 and the central control apparatus 140 S610.

Then, the apparatus including the camera apparatus 110, the sensor apparatuses 130 to 134 and the central control apparatus 140 corrects and synchronizes the embedded synchronization clock to the correction time information based on the correction time information and the time correction command received from the synchronization apparatus 120, and transmits a synchronization completion command informing completion of the synchronization to the synchronization apparatus 120.

Accordingly, the synchronization apparatus 120 receives the synchronization completion command informing completion of synchronization as a time correction performed based on the correction time information from the apparatus including the camera apparatus 110, the sensor apparatuses 130 to 134 and the central control apparatus 140 5612.

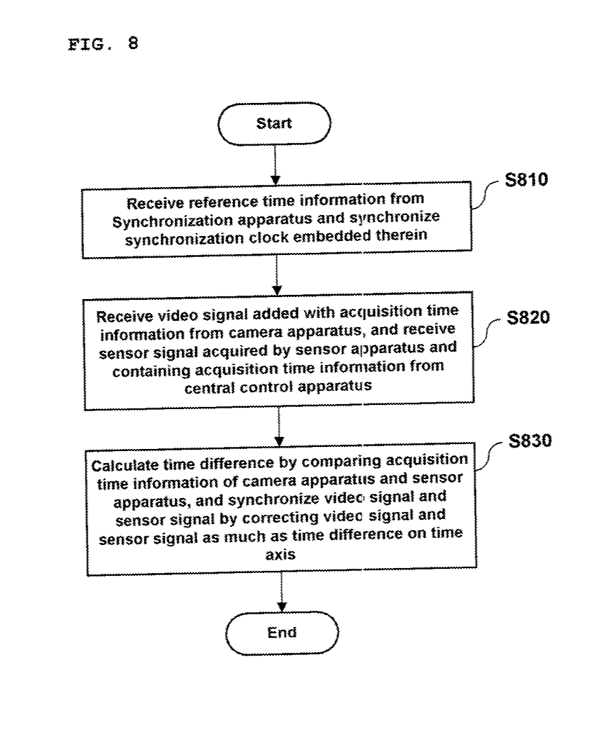

FIG. 8 is a flowchart illustrating a method of synchronizing a video signal and a sensor signal of a computer apparatus according to an embodiment of the present invention.

Referring to 8, the computer apparatus 150 according to the present invention receives reference time information from the synchronization apparatus 120 and synchronizes a synchronization clock embedded therein 5810.

Next, the computer apparatus 150 receives a video signal added with acquisition time information from the camera apparatus 110 and receives a sensor signal acquired by the sensor apparatuses 130 to 134 and added with acquisition time information from the central control apparatus 140 5820.

Next, the computer apparatus 150 synchronizes the video signal and the sensor signal based on the acquisition time information S830.

That is, the computer apparatus 150 calculates a time difference by comparing the acquisition time information of the camera apparatus 110 and the sensor apparatuses 130 to 134 and synchronizes the video signal and the sensor signal by correcting the video signal and the sensor signal as much as the time difference on the time axis.

Meanwhile, since the video signal and the sensor signal can be desynchronized while the video signal and the sensor signal are acquired from the camera apparatus 110 and the sensor apparatuses 130 to 134, the computer apparatus 150 should verify the synchronization after the signals are acquired. Accordingly, the central control apparatus 140 calculates a time difference between the camera apparatus 110 and the sensor apparatuses 130 to 134 and transfers the calculated time difference to the computer apparatus 150, and the computer apparatus 150 corrects corresponding information as much as the transferred time difference on the time axis. Of course, it is possible that the central control apparatus 140 does not calculate the time difference, and the computer apparatus 150 calculates the time difference by itself and corrects the video signal and the sensor signal as much as the time difference.

According to the present invention described above, it is possible to implement a system and method for synchronizing a video signal and a sensor signal, a camera apparatus, a synchronization apparatus and a method of synchronizing a video signal and a sensor signal thereof, and a computer apparatus and a method of synchronizing a video signal and a sensor signal thereof, in which a synchronization clock is embedded in each sensor module and a camera apparatus to synchronize the video signal inputted from a camera and the sensor signal corresponding to each video signal. The synchronization apparatus transmits a synchronization signal to each apparatus, and the synchronization clocks are synchronized according to the synchronization signal. Then, signals acquired by each sensor module and the camera apparatus are added with an acquisition time and transmitted to a central control apparatus and a computer apparatus, and synchronization is performed for the video signal and the sensor signal.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

The present invention can be applied to a system and a service that should provide video signals acquired from a camera apparatus and sensor signals acquired from a sensor apparatus as a screen and a sound simultaneously.

In addition, the present invention can be applied to an apparatus which generates a video signal and a sensor signal and transmits the signals in a wireless or wired communication.

Furthermore, the present invention can be applied to an apparatus, a system or the like which analyze multi-channel video signals and sensor signals.

1. A system for synchronizing a video signal and a sensor signal, the system comprising:
a camera apparatus embedded with a first synchronization clock, for acquiring the video signal by photographing a subject, adding acquisition time information of the first synchronization clock to the acquired video signal, and outputting the video signal;
a sensor apparatus embedded with a second synchronization clock, for generating the sensor signal corresponding to the video signal according to a sensing operation, adding acquisition time information of the second synchronization clock to the generated sensor signal, and outputting the sensor signal;
a central control apparatus for controlling to receive the sensor signal added with the acquisition time information from the sensor apparatus and transmit the sensor signal to a computer apparatus;
a synchronization apparatus embedded with a reference clock, for simultaneously transmitting a reference time for synchronizing the first synchronization clock and the second synchronization clock to the camera apparatus and the sensor apparatus at regular intervals; and
a computer apparatus for receiving the sensor signal added with the acquisition time information from the central control apparatus, receiving the video signal added with the acquisition time information from the camera apparatus, confirming the acquisition time information of each of the video signal and the sensor signal, reconfiguring each of the signals in a same time zone, and synchronizing the video signal and the sensor signal.

2. The system according to claim 1, wherein the camera apparatus synchronizes the first synchronization clock based on the reference time received from the synchronization apparatus, adds acquisition time information of the first synchronization clock to the photographed and acquired video signal, and transmits the video signal to the computer apparatus.

3. The system according to claim 1, wherein the sensor apparatus synchronizes the second synchronization clock based on the reference time received from the synchronization apparatus, adds acquisition time information of the second synchronization clock to the sensor signal generated according to a sensing operation, and transmits the sensor signal to the central control apparatus.

4. The system according to claim 3, wherein the sensor apparatus compares the reference time received from the synchronization apparatus with a time of the second synchronization clock, performs correction as much as a time difference, adds acquisition time information to the sensor signal based on the corrected time, and transmits the sensor signal to the central control apparatus.

5. The system according to claim 1, wherein the camera apparatus and the sensor apparatus obtain a time difference by comparing the reference time received from the synchronization apparatus with a time of the first synchronization clock and a time of the second synchronization clock, and transmit the obtained time difference to the computer apparatus respectively, and the computer apparatus corrects the video signal and the sensor signal as much as the time difference on a time axis.

6. The system according to claim 1, wherein the synchronization apparatus requests and acquires current time information from the sensor apparatus, confirms a time difference range by comparing the acquired current time information with reference time information, and transmits time information and a time correction command to The sensor apparatus if correction is needed.

7. The system according to claim 6, wherein if the time correction command is received, the sensor apparatus performs correction based on the time information, performs synchronization using a clock received from the synchronization apparatus at a second clock, and transmits a correction completion command to the synchronization apparatus.

8. A synchronization apparatus comprising:
a communication unit for communicating with a camera apparatus, a sensor apparatus, a central control apparatus and a computer apparatus;
a frequency generation unit (oscillator) for generating a frequency signal in order to transmit reference time information for synchronization to the camera apparatus, the sensor apparatus, the central control apparatus and the computer apparatus;
a synchronization clock unit for generating into a clock signal from the generated frequency signal;
a reference time module unit (FPGA) for generating the reference time information from the generated clock signal;
a real-time clock (RTC) unit for providing the reference time module unit with a real time clock (RTC); and
a control unit for controlling the frequency generation unit, the synchronization clock unit and the reference time module unit to generate the reference time information and control to transmit the generated reference time information to the camera apparatus, the sensor apparatus, the central control apparatus and the computer apparatus.

9. The apparatus according to claim 8, wherein the control unit requests and acquires current time information from the sensor apparatus, confirms a time difference range by comparing the acquired current time information with the reference time information, and transmits time information and a time correction command to the sensor apparatus if correction is needed.

10. The apparatus according to claim 8, further comprising:
an A/D converter for converting an analog signal inputted from the camera apparatus, the sensor apparatus, the central control apparatus and the computer apparatus into a digital signal;
an output unit for outputting the digital signal; and
a display unit for displaying an operation of generating the reference time information, a current time information and an operation of transmitting the time correction command.

11. A sensor apparatus comprising:
a sensor for generating a sensor signal sensing a slope, tension, weight;
a signal conversion unit for converting the sensor signal of an analog form into sensor data of a digital form;
a communication unit for transmitting the sensor data to a synchronization apparatus and a central control apparatus;
a synchronization clock unit for performing synchronization using a reference time provided by the synchronization apparatus;
a memory unit for storing the sensor data;
a control unit for controlling to transmit the sensor data to the central control apparatus, receive the reference time from the synchronization apparatus and perform synchronization using the reference time, and transmit acquisition time information of the sensor data to the central control apparatus with the sensor data;
a frequency generation unit for generating a frequency signal and providing the control unit with the frequency signal; and
a real-time clock module (RTC) unit for providing the control unit with a real time clock (RTC).

12. A camera apparatus comprising:
a photographing unit for acquiring a video signal by photographing a subject;
a communication unit for transmitting the video signal to a computer apparatus or a central control apparatus and communicating with a synchronization apparatus; and
a synchronization clock unit synchronized to a reference time received from the synchronization apparatus and providing a time of acquiring the video signal.

13. A method of synchronizing a video signal and a sensor signal of a system including a camera apparatus, a sensor apparatus, a central control apparatus, a synchronization apparatus and a computer apparatus, the method comprising the steps of:
(a) transmitting synchronization time information to the camera apparatus and the sensor apparatuses by the synchronization apparatus;
(b) synchronizing an embedded synchronization clock based on the synchronization time information by the camera apparatus and the sensor apparatus, respectively;
(c) acquiring the video signal and the sensor signal, adding acquisition time information, and transmitting the video signal and the sensor signal to the computer apparatus or the central control apparatus by the camera apparatus and the sensor apparatus, respectively; and
(d) performing synchronization of the video signal and the sensor signal based on the acquisition time information by the computer apparatus.

14. The method according to claim 13, wherein in step (c), the central control apparatus transmits the sensor signal added with the acquisition time information to the computer apparatus.

15. The method according to claim 13, wherein in step (d), the computer apparatus calculates a time difference by comparing the acquisition time information of the camera apparatus and the sensor apparatus and synchronizes the video signal and the sensor signal by correcting the video signal and the sensor signal as much as the time difference on a time axis.

16. A method of synchronizing a video signal and a sensor signal of a synchronization apparatus communicating with an apparatus including a camera apparatus, a sensor apparatus, a central control apparatus and a computer apparatus through a wired or wireless communication, the method comprising the steps of:
(a) requesting and receiving current time information from the apparatus;
(b) acquiring time difference information by comparing the current time information with reference time information;
(c) generating time information for correcting the time. difference information, and transmitting the time information and a time correction command to the apparatus; and
(d) receiving a synchronization completion command informing completion of synchronization as a time correction performed based on the time information, from the apparatus.

17. A method of synchronizing a video signal and a sensor signal of a computer apparatus communicating with a camera apparatus, a sensor apparatus, a central control apparatus and a synchronization apparatus through a wired or wireless communication, the method comprising the steps of:
(a) receiving reference time information from the synchronization apparatus and synchronizing an embedded synchronization clock with the reference time information;
(b) receiving the video signal added with acquisition time information from the camera apparatus, and receiving the sensor signal acquired by the sensor apparatus and added with acquisition time information from the central control apparatus; and
(c) synchronizing the video signal and the sensor signal based on the acquisition time information.

18. The method according to claim 17, wherein step (c) calculates a time difference by comparing the acquisition time information of the camera apparatus and the sensor apparatus and synchronizes the video signal and the sensor signal by correcting the video signal and the sensor signal as much as the time difference on a time axis.
